(19) United States
(12) Patent Application Publication
(10) Pub. No.: US 2007/0164048 A1
(43) Pub. Date: Jul. 19, 2007

(54) Lotion bottle structure

(75) Inventor: Kun Lan Lou, Changhua City (TW)

Correspondence Address: TROXELL LAW OFFICE PLLC, SUITE 1404, 5205 LEESBURG PIKE, FALLS CHURCH, VA, 22041, US

(73) Assignee: Jia Hsing Enterprise Co., Ltd.

(21) Appl. No.: 11/331,280

(22) Filed: Jan. 13, 2006

(51) Int. Cl. B67D 5/52; G01F 11/00

(52) U.S. Cl. 222/137; 222/390

(57) ABSTRACT

A lotion bottle structure comprises two outer tubular cylinders adapted into a containing case assembly composed of an accommodating housing, a sealing cover, a cap body, a rotary disk, and a retaining seat wherein each outer tubular cylinder is mounted to a control unit having a push shaft, a rotary threaded tube, a collar, a positioning inner sleeve, and a base mount. A threaded rod of the push shaft is joined to an internal threaded hole of the rotary threaded tube, and the bottom of the accommodating housing is coupled to the retaining seat with the rotary disk pivotally mounted thereon to synchronically actuate both control units thereby. Therefore, lotions of different functions can be respectively filled into the two outer tubular cylinders and, via the linking mechanism of the rotary disk and the control units, simultaneously transported outwards in equivalent mixture, achieving easy carrying and convenient application thereof.

### BACKGROUND OF THE INVENTION

The present invention relates to a lotion bottle structure, comprising two outer tubular cylinders adapted into a containing case assembly composed of an accommodating housing, a sealing cover, a cap body, a rotary disk, and a retaining seat wherein each outer tubular cylinder is mounted to a control unit having a push shaft, a rotary threaded tube, a collar, a positioning inner sleeve, and a base mount; therefore, via the linking mechanism of the rotary disk and the control units, lotions of different functions can be respectively filled into the two outer tubular cylinders and transported outwards in equivalent mixture, achieving easy carrying and convenient application thereby.

Please refer to FIG. 1. Conventional portable lotion bottles are normally made in individual bottles for the loading of various lotions separately. One conventional lotion bottle 10 is made up of a tubular cylinder 11 and a covering body 12 wherein the tubular cylinder 11 has an upper end defined by an external threaded section 111, and a mouthpiece 112 with a port 1121 extending upwards on top of the external threaded section 111 thereof. The covering body 12 has an internal threaded section 121 defining the inner circumferential surface of the lower section thereon, and a semi-spherical coupling protrusion 122 extending at the inner surface of the upper section thereon. In assembly, a single lotion is filled into the tubular cylinder 11 of the lotion bottle 10, and the internal threaded section 121 of the covering body 12 is reciprocally screwed to the external threaded section 111 of the tubular cylinder 11 thereof, permitting the coupling protrusion 122 to precisely join to the port 1121 of the mouthpiece 112 thereby.

There are some drawbacks to such conventional lotion bottle. First, the lotion bottle 10 is individually made for loading a single lotion. And depending on the functions of various lotions such as a sunscreen lotion, and a moisturizing lotion etc., more than one lotion bottles 10 must be applied to carry a whole set of cosmetic preparations, uneconomically increasing the number of the lotion bottles 10 applied. In addition, only one lotion is transported from a single lotion bottle 10 to be mixed in proportion to another or more lotions transported from another or more lotion bottles 10, and the large number of lotion bottles 10 are quite inconvenient to carry and apply. Second, the coupling protrusion 122 of the covering body 12 is directly joined to the port 1121 of the mouthpiece 112 disposed at the upper end of the tubular cylinder 11. Thus, in a closed state, lotion A accommodated in the tubular cylinder 11 will get attached to the coupling protrusion 122 thereof, which makes it difficult to keep the hygiene inside the covering body 12 thereof and can cause the growth of virus therein. Third, in application as shown in FIG. 2, the mouthpiece 112 of the tubular cylinder 11 is turned upside down and the body of the tubular cylinder 11 is squeezed so that the lotion A can be transported outwards through the port 1121 thereby. In case of excessive squeezing force applied to the tubular cylinder 11 thereof, large quantity of the lotion A will be ejected outwards through the port 112 in a jiffy, which can cause a waste of the lotion in application. Fourth, when the lotion A accommodated inside the tubular cylinder 11 descends to a lower quantity, the lotion A tends to deposit at the bottom of the tubular cylinder 11. Thus, in application, it will take a long time for the lotion A to flow slowly from the bottom to the mouthpiece 112 before the tubular cylinder 11 is squeezed to eject the lotion A outwards via the port 1121. In case of untimely squeezing operation when the lotion A has not yet arrived at the mouthpiece 112, only air or discontinuous and small quantity of the lotion A will be emitted outwards, which can cause inconvenience in application thereof.

### SUMMARY OF THE PRESENT INVENTION

It is, therefore, the primary purpose of the present invention to provide a lotion bottle structure wherein a sealing cover with a cap body detachably mounted thereto is coupled to the upper section of an accommodating housing of a containing case assembly, and a retaining seat with a rotary disk pivotally mounted thereto is connected to the bottom of the accommodating housing thereof in linking mechanism with a set of outer tubular cylinders each having a control unit engaged therewith, permitting the rotary disk to synchronically actuate the ascending movement of a rotary threaded tube and a push shaft of each control unit that will push against lotion accommodated in each outer tubular cylinder to flow through guiding orifices of the sealing cover and come out through a port in even proportion; thus, depending on the requirement, two different kinds of lotions can be packed together in one container and simultaneously transported outwards in equivalent mixture, efficiently reducing the number of separate lotion bottles applied as well as facilitating an easier carrying and convenient application thereof.

It is, therefore, the second purpose of the present invention to provide a lotion bottle structure wherein the sealing cover has an assembling portion with a first locking portion defined by multiple ringed ribs disposed at the inner surface thereon, and a covering portion with two conic grooves each defined by a second locking portion extending at the inner side therein wherein the first and the second locking portions are applied to simultaneously fit to the opening edges of the accommodating housing and the outer tubular cylinders extending outside the accommodating housing in one set so that the lotions can be synchronically squeezed to flow out through the guiding orifices and the port of the sealing cover in equivalent mixture, achieving the convenient and synchronic open/close of the lotions for application or storage thereof.

It is, therefore, the third purpose of the present invention to provide a lotion bottle structure wherein via the linking actuation of the rotary disk, the push shaft and the rotary threaded tube of the control unit will synchronically ascend in straight line and advance towards a receiving chamber of the outer tubular cylinder, and the lotion accommodated in the receiving chamber will be squeezed by a push-abutment portion of the push shaft to flow through the guiding orifices and come out via the port of the sealing cover thereof; thus, the push shaft is ensured to ascend straight without going awry and, thus, reduced in the risk of wearing-off in operation so that the lotion can be transported outwards in incessant frequency without interruption, achieving more accurate and better application state thereby.

It is, therefore, the fourth purpose of the present invention to provide a lotion bottle structure wherein each outer tubular cylinder has a stop flange with abutting protrusions extending at the upper section thereon to couple with fitting recesses defining both lateral side edges of a receiving opening of the accommodating housing thereon for location thereby, permitting the upper neck section of the outer tubular cylinder positioned by the stop flange thereof to stably extend outside the accommodating housing without tilting or swinging so that lotions can be quickly filled into the two outer tubular cylinders and the sealing cover can be fitted to the openings of the accommodating housing and the two outer tubular cylinders simultaneously, economically utilizing one containing case assembly to carry various lotions and one sealing cover to close or open the containing case assembly for application without multiple separate lotion bottles required to achieve the convenience of application thereby.

### BRIEF DESCRIPTION OF THE DRAWINGS

FIG. 1 is an assembled cross sectional view of a conventional lotion bottle structure.

FIG. 2 is a diagram showing the conventional lotion bottle in application.

FIG. 3 is an exploded perspective view of the present invention.

FIG. 4 is a diagram showing the inner side of a sealing cover of the present invention.

FIG. 5 is an assembled perspective view of the present invention.

FIG. 6 is an assembled cross sectional view of the present invention.

FIG. 7 is a partially enlarged and assembled cross sectional view of an outer tubular cylinder and a containing case assembly of the present invention.

FIG. 8 is a partially enlarged and assembled cross sectional view of a control unit and a rotary disk of the present invention.

FIG. 9 is a diagram showing the control units synchronically rotated by the rotary disk of the present invention in application.

FIG. 10 is a diagram showing the present invention in application.

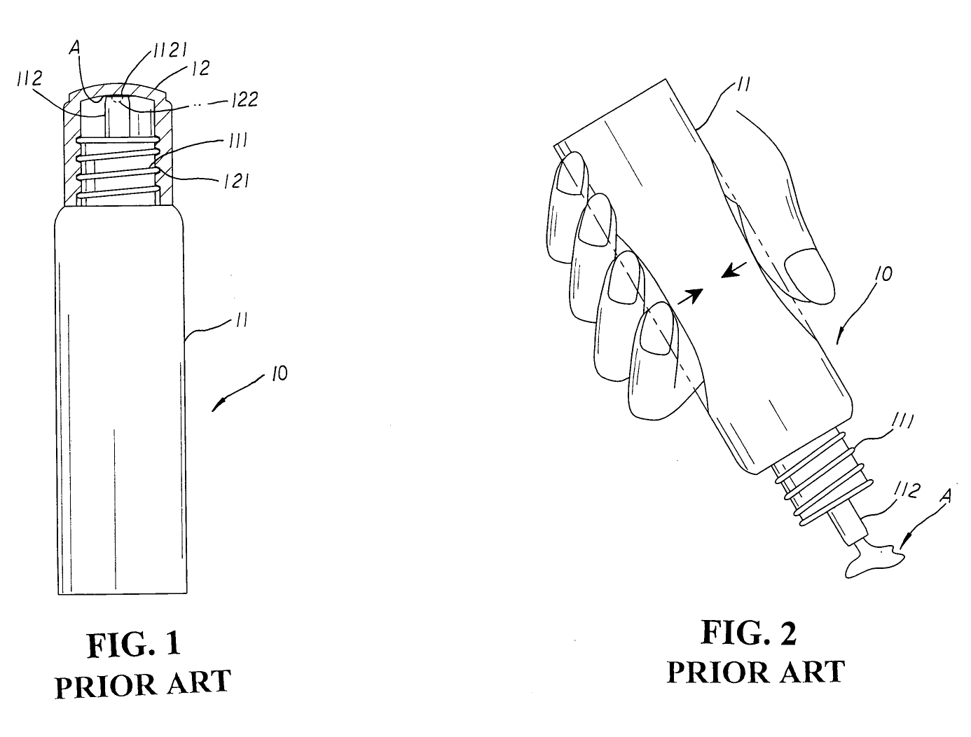

### DETAILED DESCRIPTION OF THE PREFERRED EMBODIMENTS

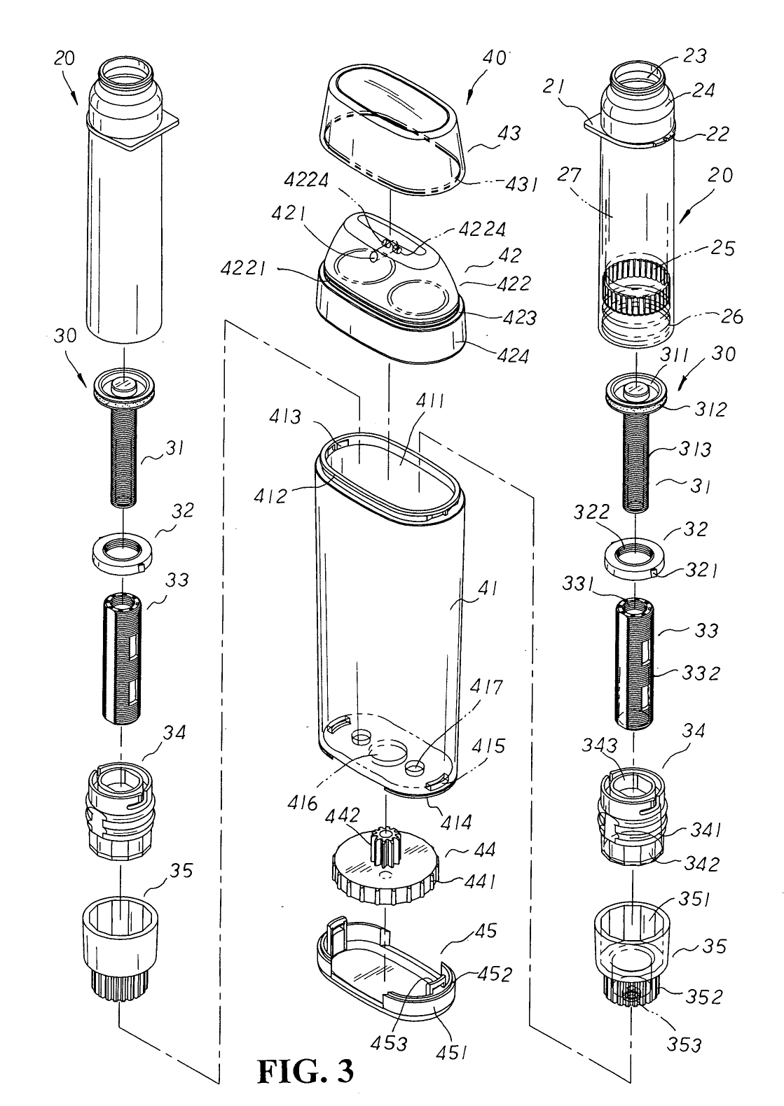

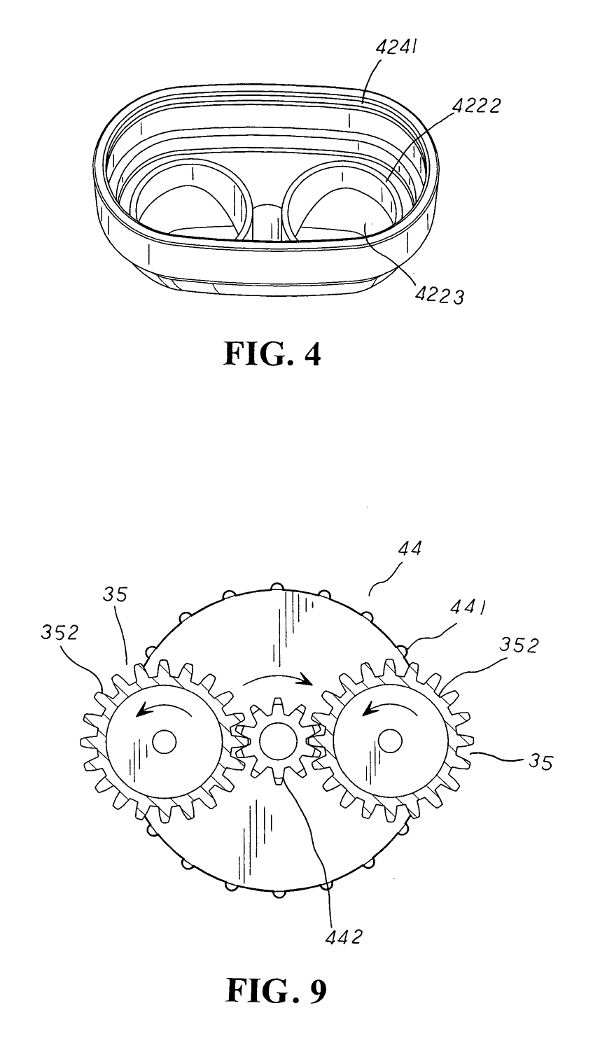

Please refer to FIG. 3 showing an exploded perspective view of the present invention. The present invention relates a lotion bottle structure, comprising two outer tubular cylinders 20, two control units 30, and a containing case assembly 40 wherein each outer tubular cylinder 20 is made in a hollow tube having a stop flange 21 appropriately extending at the outer periphery of the upper end thereon, and abutting protrusions 22 extending at one side of the stop flange 21 thereon. The outer tubular cylinder 20 also includes an upper neck section 24, and a smaller-step coupling opening 23 with ribs annularly protruding thereon is disposed on top of the upper neck section 24 thereof. The lower end of the outer tubular cylinder 20 has a plurality of identically-tilting and oblique-corner guide blocks 25 annularly arranged at appropriate positions of the inner wall thereon, and a plurality of ringed recesses 26 defining the inner surface beneath the guide blocks 25 thereof. And a receiving chamber 27 is situated above the guide blocks 25 thereof. The two control units 30 are symmetrically arranged to mount into the two juxtaposed outer tubular cylinders 20 respectively. Each control unit 30 is composed of a push shaft 31, a collar 32, a rotary threaded tube 33, a positioning inner sleeve 34, and a base mount 35. A push-abutment portion 311 with a sealing ring 312 mounted thereon is disposed at the upper edge of the push shaft 31 thereon, and a left-hand tooth threaded rod 313 extends downwards at the underside of the push-abutment portion 311 thereof. The collar 32 has a set of oblique-corner abutting blocks 321 symmetrically disposed at the outer circumferential thereon, and an internal threaded hole 322 defining the center therein. The rotary threaded tube 33 has a right-hand tooth threaded hole 331 defining the center therein, and the outer periphery of the rotary threaded tube 33 is defined by a threaded section 332 with a pair of parallel-extending plane surfaces symmetrically cut at both sides thereon. The positioning inner sleeve 34 is made in a hollow shape, having multiple ringed protrusive ribs 341 defining the outer periphery of the middle section thereon, and a polygonal-shaped coupling end 342 disposed at the lower section thereon. A coupling hole 343 with a set of plane faces symmetrically cut in parallel at both side surfaces thereon is disposed extending through the center of the positioning inner sleeve 34 thereof. The base mount 35 has a polygonal-shaped coupling cavity 351 defining the interior of the upper section therein, and a smaller-step gear shaft 352 extending at the lower section thereon. The gear shaft 352 has an axle block 353 protruding downwards from the center of the underside thereon. The containing case assembly 40 is made up of an accommodating housing 41, a sealing cover 42, a cap body 43, a rotary disk 44, and a retaining seat 45. The accommodating housing 41 has a receiving opening 411 and a smaller-step insert portion 412 defined by ribs disposed at the upper end edge thereon, and fitting recesses 413 are symmetrically cut at both lateral side edges of the receiving opening 411 thereon. The bottom section of the accommodating housing 41 has a passageway 416 disposed at the center thereon, and two locating thru-holes 417 are symmetrically arranged adjacent to the passageway 416 thereof. The accommodating housing 41 also includes two appropriate-length insert ribs 414 and two insert grooves 415 disposed at both outer lateral edges of the bottom end thereon. The sealing cover 42 has an oblique-conic covering portion 422 with a port disposed thereon 421 disposed at the upper section thereon, and an annularly ribbed fitting portion 4221 protruding at the bottom edge of the covering portion 422 thereon. A larger-step assembling portion 424 is provided extending downwards at the bottom of the covering portion 422, permitting a restricting flange 423 to form at the conjoining section of the covering portion 422 and the assembling portion 424 there-between. The covering portion 422 is allowed to fit to the cap body 43 having a snap-on portion 431 with abutting rings defining the internal surface thereon. Furthermore, the inner surface of the sealing cover 42, referring to FIG. 4, has a first locking portion 4241 with multiple ringed ribs defining thereon disposed in a position corresponding to the bottom section of the assembling portion 424 thereof, and inside the sealing cover 42 is disposed two conic grooves 4223 spaced to juxtapose in positions corresponding to the covering portion 422 thereof. Each conic groove 4223 has an annularly ribbed second locking portion 4222 protruding at the end edge thereon, and a guiding orifice 4224 extending at the upper section thereon to fluidly connect to the port 421 disposed at the upper section of the covering portion 422 thereby. The rotary disk 44 has a plurality of ribs 441 orderly protruding at the circumferential surface thereon, and a gear-wheel shaft 442 extending at the center thereon. The retaining seat 45 has a limiting portion 451 with a stepwise connecting end 452 of appropriate length extending at both outer lateral edges thereon respectively, and both opposite limiting portions 451 have a connecting block 453 protruding at the inner side thereon respectively.

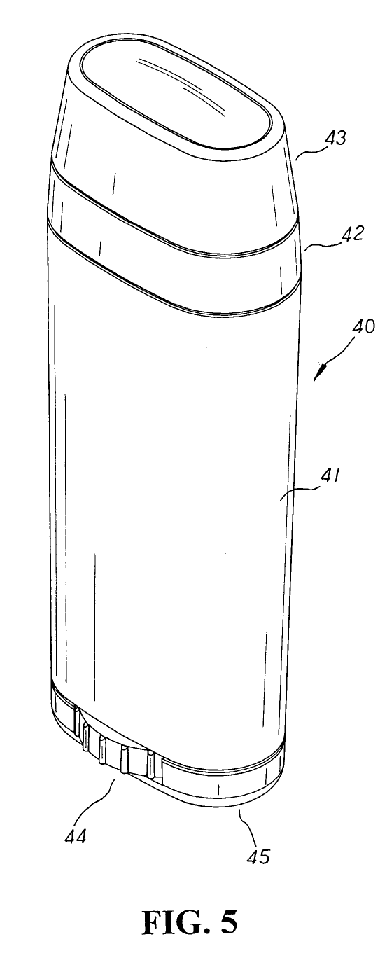

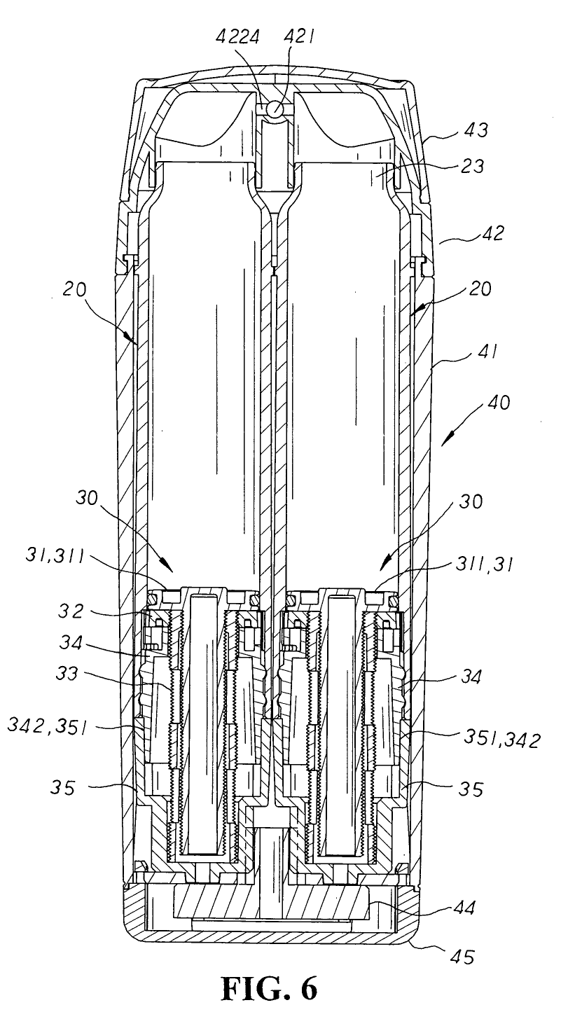

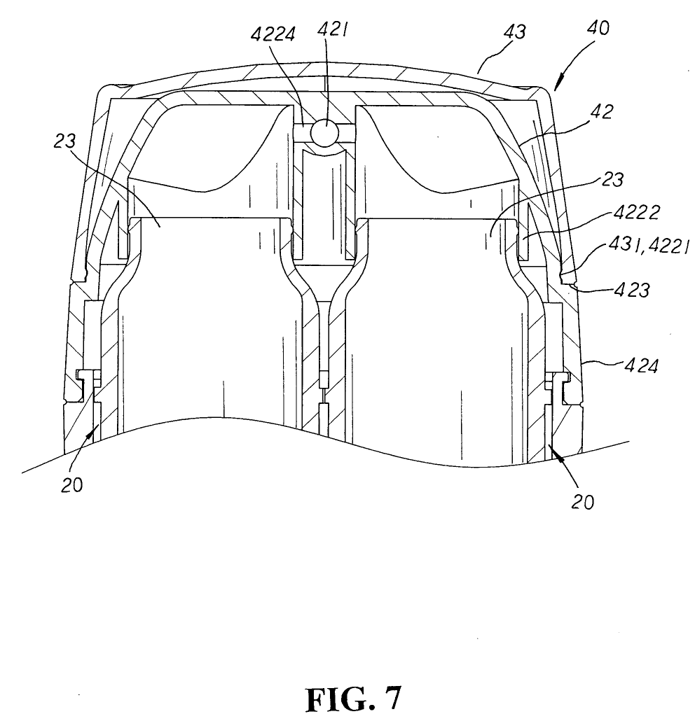

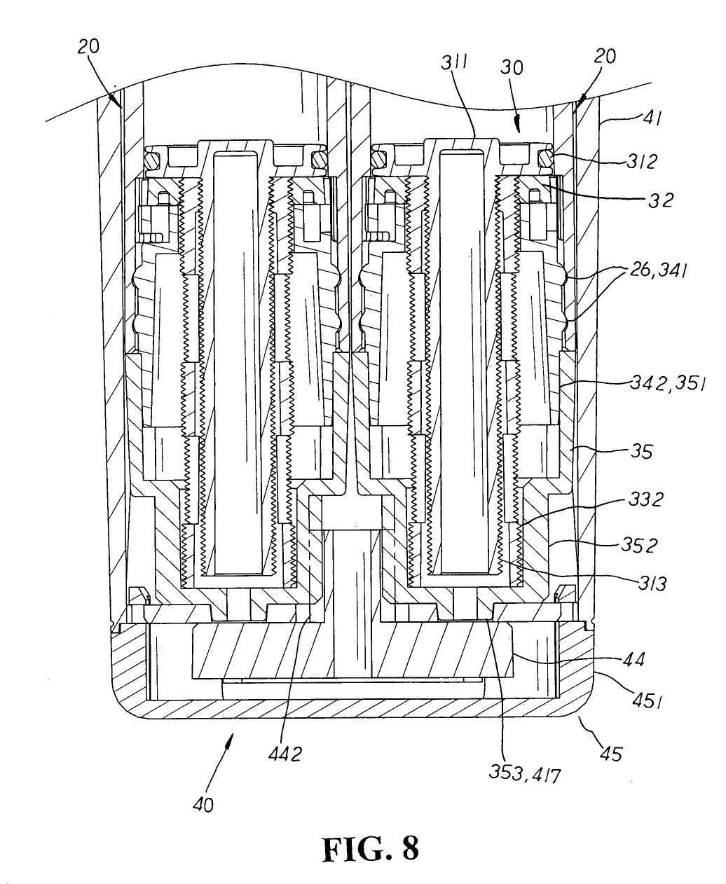

In assembly as shown in FIGS. 5 to 8 inclusive, the rotary disk 44 of the containing case assembly 40 is placed into the inner space defined by the two opposite limiting portions 451 of the retaining seat 45. Then, the connecting portion 452 disposed at the outer edges thereon and the two connecting blocks 453 are respectively joined to the insert ribs 414 and the insert grooves 415 disposed at the bottom section of the containing case assembly 40 and securely engaged therewith, permitting the central gear-wheel shaft 442 of the rotary disk 44 to simultaneously extend through the central passageway 416 for location therein. The internal threaded hole 322 of the collar 32 is applied to reciprocally screw up to the threaded section 332 of the rotary threaded tube 33 till the abutting blocks 321 are securely fitted to the guide blocks 25 of the outer tubular cylinder 20 thereof. Then, the threaded hole 331 of the rotary threaded tube 33 and the threaded rod 313 of the push shaft 31 are reciprocally screwed up to each other, and the positioning inner sleeve 34 is applied from bottom to top to mount the coupling hole 343 to the threaded section 332 of the rotary threaded tube 33 till the ringed-shaped protrusive ribs 341 are reciprocally engaged with the ringed recesses 26 of the outer tubular cylinder 20. The coupling cavity 351 of the base mount 35 is joined to the coupling end 342 of the positioning inner sleeve 34 till securely abutted against the bottom end edge of the outer tubular cylinder 20. Then, the axle block 353 protruding at the central bottom surface of the base mount 35 is coupled to one of the locating thru-holes 417 symmetrically disposed at the bottom side of the accommodating housing 41, permitting the teeth of the gear shaft 352 extending at the lower section of the base mount 35 to precisely mesh with the toothed section of the gear-wheel shaft 442 of the rotary disk 44 thereby. Meanwhile, the abutting protrusions 22 disposed at one side of the stop flange 21 of the outer tubular cylinder 20 are reciprocally inserted to the fitting recesses 413 defining both lateral side edges of the receiving opening 411 of the accommodating housing 41 for location thereby, permitting the upper neck section 24 of the outer tubular cylinder 20 to stably extend outside the accommodating housing 41 thereof, and both sides of the gear-wheel shaft 442 of the rotary disk 44 to respectively mesh with one outer tubular cylinder 20 equipped with the control unit 30 thereof. Therefore, various lotions as required (such as sunscreen and moisturizing lotions, and whitening and moisturizing lotions, etc.) can be respectively filled into the receiving chambers 27 of the two outer tubular cylinders 20. Then, the snap-on portion 431 of the cap body 43 is applied to attach to the fitting portion 4221 of the covering portion 422 thereof and abut against the restricting flange 423 of the sealing cover 42 for location thereon. The assembling portion 424 of the sealing cover 42 is pressed into position and mounted to the opening neck edge of the receiving opening 411 of the accommodating housing 41 thereon, permitting the annularly ribbed first locking portion 4241 disposed at the lower inner surface of the assembling portion 424 thereon to precisely fit to the insert portion 412 of the accommodating housing 41, and the coupling opening 23 of the outer tubular cylinder 20 to precisely seal onto the second locking portion 4222 in close engagement therewith to complete the assembly of the present invention.

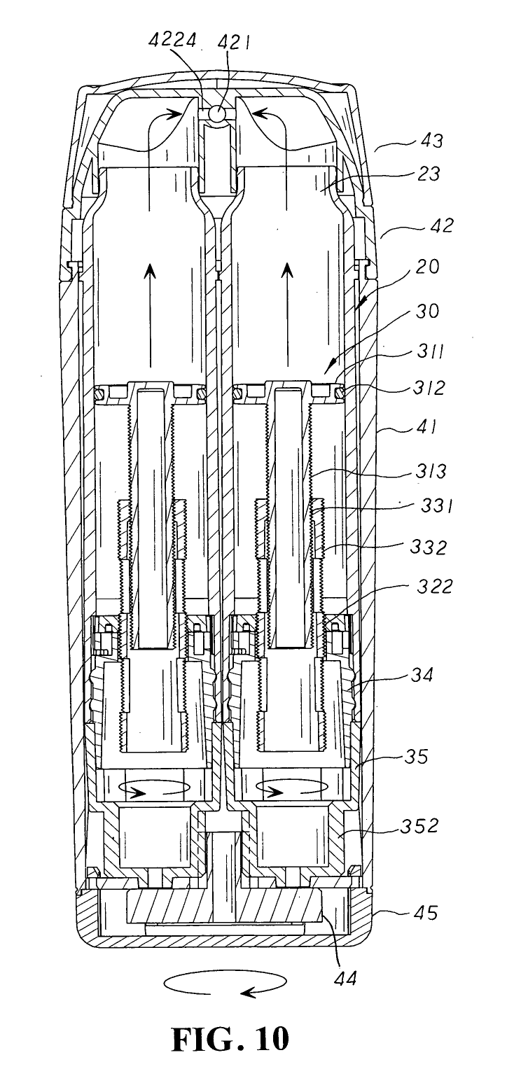

Please refer to FIGS. 9, 10. In application, the cap body 43 is pulled upwards and removed, and the rotary disk 44 pivotally mounted onto the retaining seat 45 is rotated to one side to actuate the linking mechanism of the control units 30 situated at both sides of the accommodating housing 41 therein. Meanwhile, the rotary threaded tube 33 and the push shaft 31 are synchronically actuated to advance in straight line step by step towards the receiving chamber 27, permitting the lotions accommodated in the two outer tubular cylinders 20 and squeezed by the push-abutment portion 311 thereof to sequentially flow through the conic grooves 4223 and the guiding orifices 4224 of the sealing cover 42 and come out through the port 421 disposed at the outer side of sealing cover 42 for application thereof. Therefore, the lotions accommodated in the two outer tubular cylinders 20 can be transported in equivalent proportion and emitted in even mixture through the port 421 by single operation, economically controlling the quantity of the lotions transported to avoid sudden squeezing of the lotions in a large quantity or unevenly mixture of the lotions emitted and achieve convenient application and easy carrying thereby.

What is claimed is:

1. A lotion bottle structure, comprising a containing case assembly into which two outer tubular cylinders each having a control unit mounted thereto are adapted and located at both side therein wherein the containing case assembly is composed of an accommodating housing, a sealing cover, a cap body, a rotary disk, and a retaining seat; the sealing cover is coupled with the cap body, and the bottom section of the accommodating housing is mounted to the retaining seat, permitting the rotary disk pivotally mounted onto the retaining seat to synchronically actuate the two control units situated at both sides thereof each ascending along the inner wall of the outer tubular cylinder to squeeze the lotion accommodated in the outer tubular cylinder; therefore, more than one lotions can be transported by single operation and emitted outwards from both outer tubular cylinders in equivalent mixture, economically reducing separate bottles required for carrying various lotions to facilitate easy carrying as well as convenient application thereby.

2. The lotion bottle structure as claimed in claim 1 wherein the outer tubular cylinder is made in the form of a hollow tube.

3. The lotion bottle structure as claimed in claim 1 wherein the upper section of the outer tubular cylinder has a stop flange extending at an appropriate position of the outer periphery thereon, and abutting protrusions protruding at one side of the stop flange thereon; a smaller-step and annularly ribbed coupling opening is disposed extending on top of the upper neck section of the outer tubular cylinder, and multiple identically-tilted and oblique-corner guide blocks are annularly arranged at appropriate positions within the lower section of the outer tubular cylinder thereon; a plurality of ringed recesses are disposed beneath the guide blocks and a receiving chamber is situated above the guide blocks thereof.

4. The lotion bottle structure as claimed in claim 1 wherein the control unit is composed of a push shaft, a collar, a rotary threaded tube, a positioning inner sleeve, and a base mount.

5. The lotion bottle structure as claimed in claim 4 wherein the upper edge of the push shaft thereof is equipped with a push-abutment portion with a sealing ring mounted thereon, and a left-hand tooth threaded rod is provided extending downwards from the underside of the push-abutment portion thereof.

6. The lotion bottle structure as claimed in claim 4 wherein the outer circumferential surface of the collar is equipped with a pair of oblique-corner abutting blocks symmetrically arranged thereon, and the center of the collar is defined by an internal threaded hole.

7. The lotion bottle structure as claimed in claim 4 wherein the center of the rotary threaded tube has a right-hand tooth threaded hole defining therein, and the outer periphery of the rotary threaded tube is defined by a threaded section with a pair of parallel-extending plane surfaces symmetrically cut at both sides thereon.

8. The lotion bottle structure as claimed in claim 4 wherein the positioning inner sleeve is made in a hollow shape.

9. The lotion bottle structure as claimed in claim 4 wherein the positioning inner sleeve has multiple ring-shaped protrusive ribs extending at the outer periphery of the middle section thereon, and a polygonal-shaped coupling end disposed at the lower section thereof; a coupling hole with a set of plane faces symmetrically cut in parallel at both side surfaces thereon is disposed extending through the center of the positioning inner sleeve thereof; the base mount has a polygonal-shaped coupling cavity defining the interior of the upper section thereof, and a smaller-step gear shaft extending at the lower section thereon wherein the gear shaft has an axle block extending downwards from the center of the underside thereon.

10. The lotion bottle structure as claimed in claim 1 wherein the accommodating housing of the containing case assembly has a receiving opening with a smaller-step and protrusive-ribbed insert portion extending at the upper end edge thereon, and fitting recesses are symmetrically cut at both lateral side edges of the receiving opening thereon; the bottom section of the accommodating housing has a passageway extending at the center thereon, and two locating thru-holes symmetrically arranged adjacent to the passageway thereof; the accommodating housing also includes an appropriate-length insert rib and an insert groove disposed at both outer lateral edges of the bottom end thereon respectively.

11. The lotion bottle structure as claimed in claim 1 wherein the sealing cover of the containing case assembly has an oblique-conic covering portion with a port disposed at the upper end thereon, and an annular-ribbed fitting portion extending at the bottom edge of the covering portion thereon; a larger-step assembling portion extends downwards at the lower end of the sealing cover, permitting a restricting flange to form at the conjoining section of the covering portion and the assembling portion there-between; furthermore, the inner surface of the sealing cover has a first locking portion with multiple ringed ribs defining thereon in a position corresponding to the bottom section of the assembling portion thereof, and inside the sealing cover is disposed two conic grooves spaced to juxtapose in positions corresponding to the covering portion thereof wherein each conic groove has an annularly ribbed second locking portion protruding at the end edge thereon, and a guiding orifice extending at the upper section thereon to fluidly connect to the port disposed at the upper section of the covering portion thereby.

12. The lotion bottle structure as claimed in claim 1 wherein the cap body of the containing case assembly thereof has a snap-on portion with abutting rings defining the internal surface thereon.

13. The lotion bottle structure as claimed in claim 1 wherein the rotary disk of the containing case assembly has a plurality of ribs protruding at the circumferential surface thereon, and a gear-wheel shaft extending at the center thereon; both lateral sides of the retaining seat has a limiting portion with a stepwise connecting end of appropriate length protruding thereon, and both opposite limiting portions have a connecting block protruding at the inner side thereon respectively.
